(19) United States
(12) Patent Application Publication
(10) Pub. No.: US 2020/0330313 A1
(43) Pub. Date: Oct. 22, 2020

(54) FOOT EXERCISE BRACE AND BALL DEVICE

(71) Applicant: Ana Karina Schwarz, Wichita, KS (US)

(72) Inventor: Ana Karina Schwarz, Wichita, KS (US)

(21) Appl. No.: 16/386,000

(22) Filed: Apr. 16, 2019

(51) Int. Cl. A61H 1/02; A61H 15/00

(52) U.S. Cl. CPC A61H 1/0266; A61H 15/00; A61H 2015/0007; A61H 2201/165; A61H 2201/164; A61H 2205/12

(57) ABSTRACT

A universal foot exercise brace and ball device with new and useful characteristics for massaging the plantar fascia is presented. An adjustable ankle brace surrounding the ankle connects to an elastic strip-sleeve that rests over the top portion of the foot and secures itself to a toe(s) by means of a lower elastic loop. An upper ring freely holds an elastic cord that in turn holds a spherical ball for massaging the tissue found at the bottom of the foot. Together, all the components of this foot exercise brace and ball device, work as an integrated unit enabling for a fast, safe, and easy fitting of the brace. Furthermore, this invention securely holds the ball in place while it operates rolling under all sections of the plantar fascia.

### REFERENCES CITED

| | | |
|---|---|---|
| 6,110,078 | Aug. 29, 2000 | Dyer |
| 5,399,155 | Feb. 11, 1992 | Cooper |
| 8,241,232 B2 | Aug. 14, 2012 | Sanders |
| 10,130,549 | Nov. 20, 2018 | Balducci |
| 5,039,093 | Aug. 13, 1991 | Collier |
| 5,257,969 | Nov. 2, 1993 | Mance |
| 5,609,568 | Mar. 11, 1997 | Andrews |
| 5,928,173 | Jul. 27, 1999 | Unruh |
| 5,897,520 | Apr. 27, 1999 | Gerig |
| 7,354,413 | Apr. 8, 2008 | Fisher |
| 8,357,110 | Jan. 22, 2013 | Frierson |
| 9,387,108 | Jul. 12, 2012 | Darby, II |

### BACKGROUND OF THE INVENTION

### 1. Field of the Invention

The present invention relates to the field of exercise/massage devices and more specifically to those designed exclusively for the foot and ankle.

### 2. Related Art

Plantar fasciitis is a condition that affects the connective tissue supporting the arch of the foot. When inflamed, this tissue causes intense pain in the heel and bottom of the foot. Current studies show that about 90% of people suffering from this ailment will improve their symptoms through a variety of conservative treatment methods that include proper exercise and massage of the plantar fascia. Several devices (splints, arch support socks, and ankle braces) exist directed at treating this particular disorder. Although those methods properly emphasize the use of a static dorsiflexion force of the foot to stretch the plantar fascia, they also fall short at providing a massaging element to treat this area of the body. Conversely, the present invention differs from current conventional art in that it does not involve a dorsiflexion force of the foot. It rather offers an aid in rehabilitation exercise attributing significance to conditioning the tissue found at the bottom of the foot by applying controlled massage and pressure to all sections of the plantar fascia.

A few solutions aimed at easing the pain associated with plantar fasciitis found in prior art follow:

U.S. Pat. No. 6,110,078 issued to Dyer on Aug. 29, 2000, is a device consisting primarily of two hinged plates with a variable tensioning mechanism. Applied to the foot and lower leg the device provides a progressive stretch for planter fascia, Achilles tendon, and gastrocnemius muscle. Enhancements, comprised of an adjustable toe support, adjustable arch support, and foot strap enable maximization of stretch for various foot types and conditions. A method of setting tension levels allows for application of protocol and, in conjunction with the use of a system to measure angular displacement of the plates, provides a method of evaluating flexibility and flexibility gains of the plantar fascia/Achilles tendon system.

The Dyer stretching device offers tension mechanisms where significance is attributed solely to a progressive stretching of the plantar fascia as opposed to our device where significance is attributed to applying pressure and massage to the plantar fascia.

U.S. Pat. No. 5,399,155 issued to Cooper on Feb. 11, 1992, presents a foot and leg-stretching device wherein the heel, ball and arch of the foot remain flat on a footplate while the toes are inclined upwardly against a selectively position able plate. The device is designed to simultaneously stretch the Achilles tendon cord, arch of the foot and calf muscles.

The Cooper stretching device is not only cumbersome to manufacture and use, but lacks functional design and once again, it does not offer a massaging solution for the bottom of the plantar fascia.

U.S. Pat. No. 8,241,232 B2, issued to Sanders on Aug. 14, 2012 describes a foot pain relief device that provides multiple angles of inclination, directed pressure against the plantar fascia, as well as ease of manufacturing and assembly. A toe strap, which is fastened around the ankle and the toe(s), ensures that the toes are flexed up. This toe flexing tenses the plantar fascia of the foot. A ball strap can be threaded through a hole in a ball and then operatively coupled with the toe strap. When operatively coupled to the toe strap, the ball strap keeps the ball positioned on the bottom of the foot while allowing ball mobility. The mobility of the ball can provide directed pressure on at least one component of the plantar fascia. Notably, the simultaneous combination of tension to the plantar fascia and directed pressure to the component(s) of the plantar fascia can be particularly effective at relieving foot pain.

The Sanders device, presents at least three problems (there maybe more). First, lack of functional design is evident. The user must assemble three parts together in his/her foot in order to use the contraption. Second, there is no mechanism securely attaching the device to the foot, therefore parts just fall apart at any given moment. Third, the toe strap and the ball strap operate coupled and held together at the sides with double-sided Velcro (where they touch). However, we know that Velcro is generally used to fasten things in a fixed position as opposed to providing mobility. Therefore, its use in the manner described by Sanders renders the design useless in providing directional flexibility when rolling the ball under the foot.

U.S. Pat. No. 10,130,549 B2 Issued to Balducci on Nov. 20, 2018 describes a physical therapy ball comprising inner and outer hallow spherical bodies. A web positions the inner spherical body with respect to the outer spherical body to form a gap there between. The gap is filled with a high heat capacity gel. An array of conical sections extends from the outer surface of the outer spherical body to facilitate foot massage.

This device presents one fundamental flaw. It lacks a mechanism for attaching it to any part of the body, thereby making it impossible to control the ball under the foot. In this application, the ball might roll away under a piece of furniture (for example, under the bed) in consequence, the user would have to stop exercising and get down on his/her knees to retrieve the ball. This might happen several times during the exercise session making its use very inconvenient.

As explained above, prior art in this field teach several exercising devices all of which correctly emphasize the need of stretching the plantar fascia; nevertheless, there is still a need for a reliable and functional device that properly emphasizes and delivers a method of applying massage and pressure to the plantar fascia.

In consequence, the primary purpose of the present invention is to deliver a novel exercise device for rehabilitating the plantar fascia with the following demonstrable advantages:

a) Original design characteristics

b) Movable flexibility, reliability, and functionality for the user

c) A cost effective exercise solution

Our device, clearly displays evidence of original design characteristics. The novel configuration of all its parts, built in conjunction, delivers an integrated unit device that enables easy, fast, and safe application on the foot. A second advantage is the elasticity of the construction materials employed, which deliver universal one-size-fits-all original design characteristics of flexibility, reliability, and functionality of use. A third advantage is evident in the simplicity of the design, which allows for a cost effective exercise solution. These three advantages will become more evident in the detailed drawings and description down below.

### SUMMARY OF THE INVENTION

The present foot exercise/massage invention is a novel four-section system built to operate as a universal integrated unit. Each section separately comprises:

Section 1) an ankle brace member, which securely loops and fastens around the ankle of the user.

Section 2) an elastic strip-sleeve member directly connected to the brace section resting exactly on the top section of the foot. This strip-sleeve section furthermore includes two other support members:

a) An attached pin/ring component exemplified by a circular base, a raised stem, and a ring support member; and

b) A frontal toe loop component attached to the underside of the strip-sleeve member.

Section 3) an elastic cord member unrestrictedly threaded through two key points the pin/ring and the center axis of a ball.

Section 4) a spherical exercise/massage ball member that includes an open channel crossing through its central axis.

All these section components, built together as an integrated unit device, deliver a novel foot exercise/massage device engineered for the treatment and relief of pain and inflammation caused by plantar fasciitis.

### BRIEF DESCRIPTION OF THE DRAWINGS

The accompanying drawings illustrate the present invention:

FIGS. 1 and 2 are perspective views of the four sections operating as one integrated and functional unit device.

FIGS. 3, 4, and 4A are perspective views of the ankle brace and strip-sleeve sections.

FIGS. 5 and 7 are perspective views of the elastic band and ball sections.

### DETAILED DESCRIPTION OF THE INVENTION

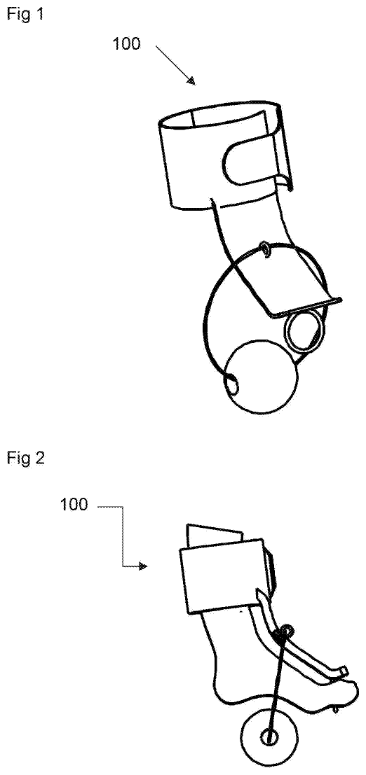

FIG. 1 presents a perspective view of the present foot brace and exercise/massage invention built to operate as a joined unit 100, FIG. 2 illustrates the same device 100 anatomically fitted on a foot and in use. As illustrated in FIG. 2, the user easily slides either foot inside the ankle brace and then secures the device with the help of a Velcro strap. Next, he/she safely puts the foot through the elastic cord (in between the strip-sleeve and the ball). Finally, he/she inserts a toe(s) through a frontal toe loop member. At this point, the user is ready to begin a controlled rolling motion of the ball under the foot (forward, backward, and lateral) with full flexibility and reliability to cover all aspects of the plantar fascia.

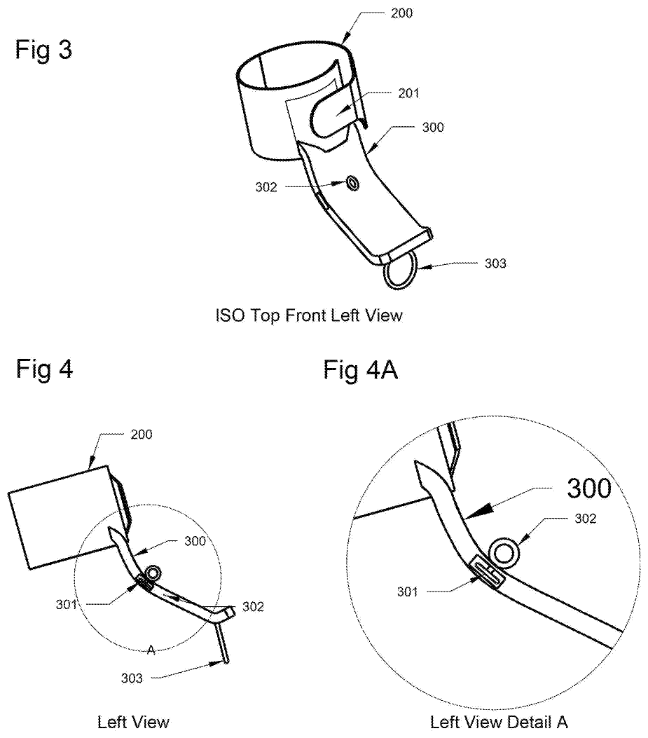

FIG. 3 illustrates an ankle brace component 200 made using multidirectional breathable material for maximum comfort in wear, said ankle brace further includes a double side Velcro strap component 201 on one end designed for securing the brace around the ankle thus achieving optimal anatomic fit.

FIG. 4 illustrates a left view of a flexible strip-sleeve component 300 directly connected to the ankle brace 200. Said strip-sleeve component configured to rest exactly on top of the foot, (over the Superior and Inferior retinaculum structure) down to the toes. Said strip-sleeve component 300 further encasing a layer of cushioned material stitched to the strip-sleeve and applied to this component to provide padding and structure to this section, thus achieving an aspect similar to the padded tongue of a sports shoe. Said strip-sleeve component 300 further comprising three other support members noted as follow: (A) an attached pin member 301 having a circular base section with a raised connecting stem section. Said circular base positioned inside the strip-sleeve component 300 with the stem piercing through the top face of the strip-sleeve, configured in this manner to avoid direct contact of the disc with the top of the foot (as depicted in FIG. 4A, Detail A enlarged for clarity). Said pin member 301 further designed to end in (B) a ring shaped member 302 visibly protruding above the strip-sleeve component 300. Said ring member 302 further designed to allow unrestricted threading of an elastic cord at this point allowing the ball freedom to operate in multiple directions as intended by the user, and (C) an elastic frontal toe loop member 303. Said toe loop component affixed to the distal underside end of said strip-sleeve 300 designed to fasten the strip-sleeve to a toe(s)

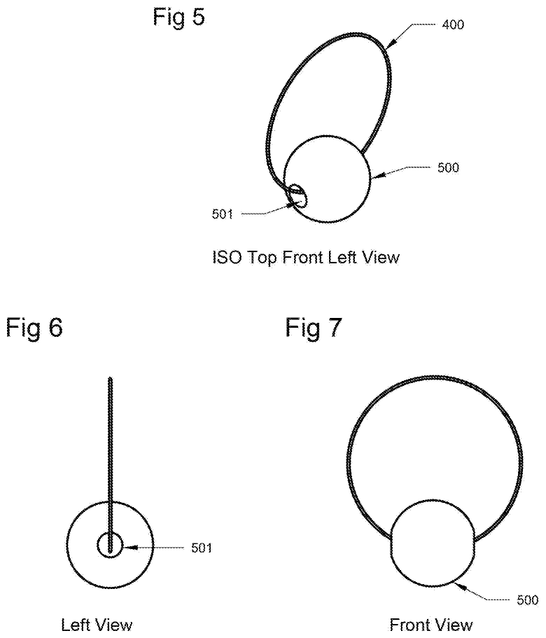

FIG. 5 illustrates an elastic cord component 400 configured to be unrestrictedly threaded through two key points; first, through ring member 302 and second, through the center channel of a ball thus allowing unrestricted movement of the ball. Said elastic cord component 400 giving the user the capability to hold a ball in position under his/her foot while also allowing flexibility to roll the ball with directional control (forward, backward, and lateral) against all sections of the plantar fascia.

FIGS. 6 and 7 further illustrate an exercise/massage ball component 500 built of both firm and semi-firm materials thus, guaranteeing a dense ball with sufficient softness suitable for applying proper pressure to the plantar fascia. Said ball further comprising a solid, yet hollow cylindrical channel 501 mounted on the center axis of the ball built to allow circulation of the elastic cord member 400. Said cylindrical channel further designed and built to provide structural support to the ball member 500 for effectively avoiding its collapse under the foot.

Lastly, is noted that any specific methods, processes and suitable materials (elastic, molded plastic, rubber, PVC blends, sports mesh, spongy, and others) that prove useful in the manufacturing and overall comfort and fit of this, device may be employed.

Having describe all the features of this invention in dear and precise terms and in accordance with the drawings, which form part of this specification, the invention claimed is:

1. A Foot Exercise Brace and Ball Device engineered for the treatment of plantar fasciitis, comprising:
(a) an adjustable ankle brace component for receiving the foot of a user, said ankle brace formed of multidirectional stretch fabric having a frontal securing strap outfitted with double side Velcro conceived to anatomically fasten the brace around the ankle;
(b) a flexible strip-sleeve component connected and expanding from the frontal portion of said ankle brace designed to rest directly on the top section of the foot (over the. Superior and Inferior retinaculum structure) down to the toes of the user, said strip-sleeve substantially configured as a thin sleeve having a layer of cushioned material stitched to said strip-sleeve and applied to this section for providing padding and structural support to said strip-sleeve;
(c) a pin-ring component characterized by a circular base section, a connecting raised stem section, and a ring section, said pin-ring mechanism having the circular base section permanently positioned inside the strip-sleeve component with the connecting stem piercing above the top face of the strip-sleeve component and the ring section distinctively protruding outside said strip-sleeve, said ping ring component configured for allowing unrestricted circulation of a threaded elastic cord;
(d) an elastic frontal toe loop component permanently attached to the distal underside end of the strip-sleeve component, said toe loop component configured for securing and fitting around a user's toe;
(e) an elastic cord component threaded through the pin-ring component, said elastic cord configured for freely engaging with an exercise ball; and
(f) an exercise/massage ball component having a firm hollowed built-in channel intersecting the center axis of the ball, said ball curved and contoured to adhere around the core channel by permanently compressing both parts against each other forming and delivering a spherical ball with structural support that prevents its collapse under the foot, said ball configured to permit unrestricted circulation of the elastic cord component,
wherein the foot exercise brace and ball device is characterized in that, all the aforementioned components are constructed to permanently engage with each other to operate as one integrated and reliable joined unit device.

2. A foot exercise brace and ball device, further characterized in that, it delivers a new operational method resulting in fast, reliable, and safe application of a unified device on and off the foot.

3. A foot exercise brace and ball device further characterized in that, it delivers a new exercise/massage ball component that effectively rolls under the foot with directional flexibility (forward, backward, lateral) efficiently covering all sections of the plantar fascia as intended by the user.
